(19) United States
(12) Patent Application Publication
(10) Pub. No.: US 2008/0300913 A1
(43) Pub. Date: Dec. 4, 2008

(54) DoMo1 VIrtual Major DoMo

(75) Inventor: Bill A. Fuchs, Alamo, CA (US)

Correspondence Address: INTEGRITY LLC;BILL FUCHS, 2951 ROUNDHILL ROAD, ALAMO, CA, 94507, US

(73) Assignee: Bill A. Fuchs, Alamo, CA (US)

(21) Appl. No.: 11/164,843

(22) Filed: Dec. 7, 2005

(51) Int. Cl. G06Q 50/00; G06Q 10/00; G06Q 30/00

(52) U.S. Cl. 705/2; 705/10; 705/8

(57) ABSTRACT

DoMo I is a suite of interactive Business Intelligence tools for the hospitality industry. DoMo I is a virtual Major Domo, by collecting and analyzing a customer's personal preferences using the proprietary PRIME© (Prospect Resource Information Management Environment). DoMo I can accurately predict a customer's individualized requirements in advance and prepare, select and schedule inventory and services to meet and exceed the customer's varied needs.

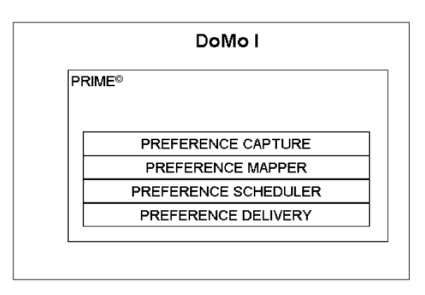

Domo Technology Systems, DoMo I is a suite of interactive Business Intelligence tools for the hospitality industry.

DoMo I is a virtual Major Domo, by collecting and analyzing a customers' personal preferences using the proprietary PRIME© (Prospect Resource Information Management Environment).

What is claimed is:

1. DoMo I can accurately predict a customer's individualized requirements in advance and prepare, select and schedule inventory and services to meet and exceed the customer's varied needs.

2. Personal Preferences can range from; information, nutrition, medical and health requirements, entertainment, business, even preferred language.

3. By analyzing a customer's habits and activities, DoMo I can offer new and unique experiences in many areas, and coordinate with a customer's existing schedule and requirements, by providing this enriching and enlightening experience opportunity any business will better serve their customers.

4. By utilizing accrued business intelligence and thereby providing better customer service, businesses will achieve maximum loyalty, improve their reference position and realize a better bottom line. Increased profitability is the goal of every business.
